(19) United States
(12) Patent Application Publication
(10) Pub. No.: US 2002/0107881 A1
(43) Pub. Date: Aug. 8, 2002

(54) Markup language encapsulation

(76) Inventor: Ketan C. Patel, North Andover, MA (US)

Correspondence Address: LAHIVE & COCKFIELD, 28 STATE STREET, BOSTON, MA, 02109, US

(21) Appl. No.: 09/775,481

(22) Filed: Feb. 2, 2001

(51) Int. Cl. G06F 15/00

(52) U.S. Cl. 707/500

(57) ABSTRACT

A method and apparatus for creating an object that includes a compacted markup language document, a reference entity, and an index entity. The object may also include a compacted DTD and a compacted stylesheet should the markup language DTD and stylesheet reside external to the markup language document. The method and apparatus also provides a means to extract specific markup content in a compacted format to expedite content retrieval in a distributed network.

### TECHNICAL FIELD

The present invention relates generally to markup language documents and more particularly to a method and apparatus for encapsulating a markup language document into an object.

### BACKGROUND OF THE INVENTION

The conventional method of conducting business with hard copies of business documents such as, purchase orders (PO's) and requests for quotes (RFQ's), is quickly becoming an antiquated concept due to continuing developments in the network technology arena of electronic commerce. As a result, business entities and even consumers are moving to a paperless method of purchasing goods and services. More significantly, the standardization and refinement of business data formats and protocols, for example, the development of the extensible markup language (XML) format, allows a business entity the opportunity to conduct all matters of business in a paperless environment. With this paradigm shift, data has never been easier to collect and report. As a result, business managers now expect and rely upon real time or near real time data for business intelligence.

As a consequence of this shift to a paperless office, a need to store and retrieve electronic data in an efficient manner becomes a critical concern of a business entity. For example, a single large corporation may generate at least 650 gigabytes of business data in a single year. The need to store and retrieve electronic business data of this magnitude presents at least three problem areas, namely, the ability to efficiently store large quantities of data, the ability to preserve any externally referenced declaration within the markup language document, and the ability to efficiently retrieve specific content from a markup language document. Hence, managing and optimizing data amounts of that magnitude for multiple business entities necessitates the use of efficient and scalable data retrieval and storage techniques.

While various techniques presently exist to efficiently store large quantities of data in a scalable manner, such as data compression, no single technique provides the technical capabilities required for use in a markup language environment. For example, many of the conventional compression methods utilize a hashing technique to produce hash values for a fixed string length. The hash values may then be indexed to indicate a string location in the compressed file. Nevertheless, because the hashing methodology utilizes a fixed string length to compress data, the technique is not suitable for use with a markup language format due to the variable length and the nestability of data elements forming the markup language document. Furthermore there is no ability for the hashing methodology to distinguish between content that represents data element delimiters from the content within the data element delimiters. As a result, it is not clear to an application wishing to retrieve specific markup content from a compressed or compacted markup language document where the specific markup content begins and ends.

Moreover, the conventional compression methods fail to preserve the integrity of any externally referenced declaration within the markup language document. Consequently, an application wishing to retrieve information from the externally referenced compressed document cannot do so because the declarations that define the document's location and content cannot be found in the application's operating environment. As such, accessing business critical data of a markup type while in a compressed state that contains external references is unreliable and often results in data retrieval errors.

A further problem associated with the management and retrieval of markup language documents to conduct business electronically is the burden of locating an externally referenced markup declaration. For example, a business entity that transmits an electronic purchase order to other business entities where the purchase order contains an external reference to a DTD having a specific location within the transmitting business entity's business system. Because the external reference location is unique to the transmitting business entity, all receiving entities experience major difficulty in locating the externally referenced DTD to process the purchase order. As such, all of the receiving business entities are burdened with creating an identical reference location within their own business system that either contains the referenced DTD or points to an alternative location where the DTD can be found. Moreover, all receiving business entities are further burdened with updating their local version of the DTD to stay current with the master DTD held by the transmitting business entity. Consequently, any efficiency gained by conducting business electronically can be easily lost should the receiving business entity not have access to the DTD referenced by the purchase order.

Yet another problem associated with managing and retrieving large amounts of data is the ability to access and retrieve specific content without having to parse an entire document. The first conventional manner to retrieve specific content from a markup document requires parsing of the entire document to create a delimiter index. Once the delimiter index is complete the application program or the parser can then retrieve the specific content requested. This conventional method of parsing an entire document each time specific document content is requested is not only a burden on the processing power and memory of the apparatus hosting the parser, but adds unnecessary latency to data retrieval.

A second conventional manner to retrieve specific content from a markup document requires parsing of the document until the specific content is located. The second conventional method of accessing and retrieving specific content from a markup language document also requires a parser to parse the markup language document each time specific content is requested.

Consequently, with either conventional parsing method, there exists no relationship between the amount of content accessed from a markup language document and the latency associated with the request. Hence, frequent requests for small amounts of data adversely effect data retrieval times. As a result, demand for real time or near real time data is not obtainable.

### SUMMARY OF THE INVENTION

The present invention addresses the above described problems of managing and accessing markup language data by creating an encapsulated format. In particular, the present invention provides a method for encapsulating a markup language document into an object that requires less memory for storage, contains any externally referenced components within the encapsulation, and facilitates extraction of specific data elements. The encapsulation method reduces the markup language document or file by 10 to 20 times its original size, provides a tag index to access markup elements, and preserves the reference integrity of any externally referenced markup declarations. In one embodiment of the present invention, a method is practiced where a compressed markup language file, an index that indicates the location of the markup elements in the compressed markup language file, and a pointer array that preserves any external reference to a markup declaration or stylesheet are encapsulated into an object. The index provides the location of tag pairs within the compressed markup language file to assist in the access and retrieval of compressed markup content. The pointer array ensures the preservation of any external reference to a DTD or a stylesheet within the markup language document by creating a version of the externally referenced DTD or stylesheet within the encapsulation object to support the extraction of markup content in a compressed format by a parser or a browser.

In accordance with one aspect of the present invention, an apparatus is provided for encapsulating a markup language document into an object for use in a distributed network. A search facility is provided that identifies the content boundary markers in a markup language document. In response to the search facility, a formatting facility formats the identified content boundary markers into a format that requires less space to store and that also formats the content within the identified content boundary markers in a format that requires less space to store to produce a compressed markup language document. Further, an index facility indexes the identified content boundary markers in a way that identifies their location and the compressed markup language document. An encapsulation facility then encapsulates the compressed markup language document and the index of boundary markers into an object that can be distributed in a distributed network. Additionally, the apparatus includes a reference facility that preserves any external reference locations contained within the markup language document in order to locate externally referenced markup declarations and stylesheets. Should the markup language document include an external reference, the reference map or pointer generated by the reference facility is also encapsulated into the markup language object. Moreover, any externally referenced markup declaration or stylesheet may be compressed as separate entities and encapsulated with the compressed markup language document, the boundary markers index, and the reference map into an object.

In accordance with a further aspect of the present invention, a computer readable medium holding computer executable instructions to perform a method to create a markup language object is provided. The computer readable medium provides the instructions necessary to locate a pair of markup language element descriptors in a markup language document and to then format the markup content within the element descriptors and the element descriptors into a format that requires less memory. Further, the computer readable medium provides instructions to generate offset value for the identified element descriptors to indicate their location in the reformatted markup language document and to generate an index of offset values to facilitate content access and extraction. The computer readable medium further provides instructions to encapsulate the reformatted markup language document and the index of offset values into a markup language object.

### BRIEF DESCRIPTION OF THE DRAWINGS

An illustrative embodiment of the present invention will be described below relative to the following drawings.

FIG. 1 depicts a block diagram of a distributed system that is suitable for practicing the illustrative embodiment.

FIG. 2 depicts an encapsulated markup language object that is suitable for practicing the illustrative embodiment.

FIG. 3 is a block diagram depicting the interaction of the encapsulated markup language object with components found in the distributed system of FIG. 1 in more detail.

FIG. 4 is a flow chart illustrating steps that are performed to create a markup language object of the illustrative embodiment.

FIG. 5 is a flow chart illustrating steps to retrieve content from a markup language object of the illustrative embodiment.

FIG. 6 is a flow chart illustrating alternative steps to retrieve content from a markup language object of the illustrative embodiment.

### DETAIL DESCRIPTION OF THE INVENTION

The illustrative embodiment provides a method and an apparatus that encapsulates a markup language document into an object to reduce memory space required to store the markup language document and to reduce latency associated with retrieving content from the markup language document in a compressed format. The encapsulated object includes the markup language document in a compressed format, an index indicating content location within the compressed markup language document, and a reference map that indicates the location of any externally referenced markup declaration or stylesheet within the compressed markup language document.

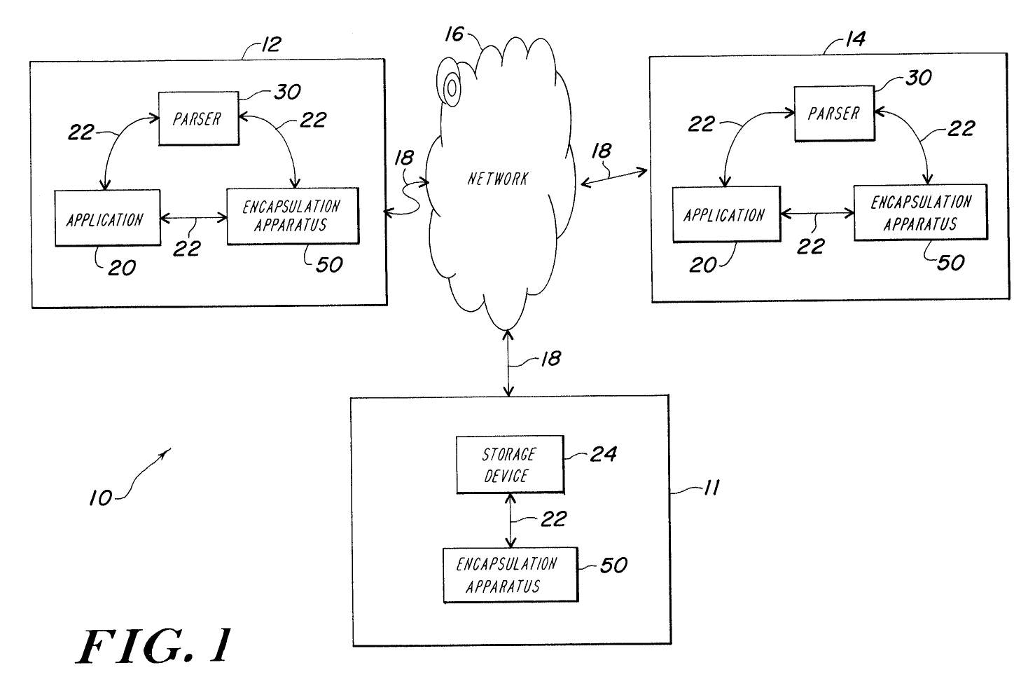

FIG. 1 depicts a distributed network 10 suitable for practicing an illustrative embodiment of the present invention. The distributed network 10 includes one or more nodes as indicated by a sender node 12, a recipient node 14, and an enterprise storage node 11. The preferred communication medium that interconnects each node in the distributed network 10 is a network 16, such as the Internet. Nevertheless, one skilled in the art will appreciate that other communication mediums are suitable for practicing the present invention, those mediums may include a virtual private network (VPN), a dedicated line, a wireless communication link, an Intranet, an Extranet, or the like. Further, one skilled in the art will recognize that the enterprise storage node 11 may be incorporated within the sender node 12 or the recipient node 14. Connecting the various nodes of the distributed network 10 with the network 16 is an interconnect 18, which may be a T1 line, a T3 line, a fiber optic cable, a wireless link, a co-axial cable, an Ethernet connection, a twisted pair, or the like.

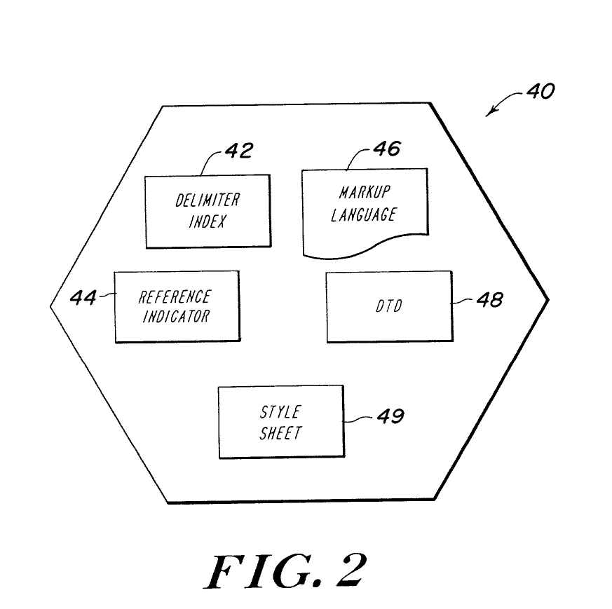

The sender node 12 includes a parser 30, the encapsulation apparatus 50, and an application program 20 that are capable of processing data in a markup language format. The parser 30, the encapsulation apparatus 50, and an application program 20 provide a node of the distributed network 10 to create, use and modify the document object 40 depicted in FIG. 2. The parser 30, the encapsulation apparatus 50, the application program 20, and the document object 40 will be explained in more detail below.

Similarly, the recipient location 14 also includes a parser 30, the encapsulation apparatus 50, and an application program 20 suitable for processing data in a markup language format. As depicted by the sender location 12 and the recipient location 14, the application program 20 communicates with both the parser 30 and the encapsulation apparatus 50. The parser 30 also communicates with the encapsulation apparatus 50. The interconnect 22 providing the communication pathway between the application program 20, the encapsulation apparatus 50, and the parser 30 may be a bi-directional bus within a computer, an Ethernet cable within a local area network (LAN), a twisted pair, a wireless link, or the like. One skilled in the art will recognize that the application program 20, the parser 30, and the encapsulation apparatus 50 may all reside on a central repository such a server, or may reside individually or collectively on a local device such as a user's laptop or desktop computer. Moreover, one skilled in the art will appreciate that the descriptive sender and the descriptive recipient are interchangeable and are provided to facilitate the detailed explanation of the illustrative embodiment.

The enterprise storage node 11 includes a storage device 24 and may include an encapsulation apparatus 50 linked to the storage device 24 via interconnect 22. The enterprise storage node 11 provides a storage device 24 and the encapsulation apparatus 50 to store significant amounts of business data from one or nodes in the distributed network 10. In this manner, the enterprise node 11 serves as a centralized data management node capable of providing an efficient means to store, access, and retrieve markup language content in a compressed format in order to support a the business manager's need of real time or near real time business intelligence from any node in the distributed system 10. Moreover, should the enterprise storage node 11 include the encapsulation apparatus 50, the need to have an encapsulation apparatus 50 at each user node would not be necessary. The application program 20 can communicate directly with the encapsulation apparatus 50 at the enterprise storage node 11 or indirectly through the parser 30 to direct the encapsulation apparatus 50 to pack a markup language document into an object for storage on the storage device 24, or to unpack a markup language object stored on the storage device 24.

The encapsulation apparatus 50 allows markup language documents, such as a hypertext markup language (HTML) document, or an extensible markup language (XML) document, to be compacted and then encapsulated as a document object. As a result, the document object achieves a ten to twenty times' reduction in size as compared to the original markup language document. Consequently, the distributed network 10 preserves system bandwidth when the document object is distributed to the various nodes in the distributed network 10. Further, the document object may be sent to the enterprise storage node 11 for storage on the storage device 24 for utilization by an authorized network node.

The employment of the encapsulation apparatus 50 on one or more nodes on the distributed network 10 provides the benefit of conserving system bandwidth when distributing or exchanging data from one node location to another. The document object created by the encapsulation apparatus 50 also provides the benefit of reducing memory space required to store a markup language document on a storage device or central repository such as, the enterprise storage node 11. A further benefit provided by the encapsulation apparatus 50 is the reduction in latency associated with accessing content from a markup language document. As will be explained below in more detail, the encapsulation apparatus provides an index of all element locations in the compacted markup document. Because the index is readable by a parser or a browser, the parser or the browser now knows the exact location of a requested element and avoids the time previously required to search or parse the document for the requested element. Consequently, content retrieval latency is significantly reduced.

FIG. 2 represents a document object 40 that encapsulates a delimiter index 42, a reference indicator 44, a compacted markup language document 46, a compacted externally referenced document type definition (DTD) 48, and a compacted externally referenced stylesheet 49. The delimiter index 42 provides a parser or a browser with an index of delimiter pairs and an offset value for each delimiter in the pair set in order to indicate the location of a delimiter pair in the compacted markup document 46. The reference indicator 44 is a map that preserves the external location integrity of any externally referenced DTD or stylesheet referenced in the compacted markup language document 46. The document object 40 represents the encapsulation of a compacted markup language document that utilizes an external document type definition (DTD) or an external stylesheet. One skilled in the art will recognize that a DTD and a stylesheet are not required for every markup language document and as such a document object may not include a DTD entity or a stylesheet entity.

One skilled in the art will understand that the document object 40 is a software entity comprising both data elements and routines or functions, which manipulate the data elements. The data and the related functions are treated by the software as a discrete entity that can be created, used, and deleted, as if they were a single item. Moreover, the document object 40 provides the principle benefits of object oriented programming techniques that arise out of the basic principles of encapsulation, polymorphism, and inheritance. More specifically, the document object 40 can be designed to hide or encapsulate, all, or a portion of, the internal data structure and the internal functions. More particularly, all or some of the data variables and all or some of the related functions in the document object 40 may be considered “private” or for use only the object itself. In like manner, other data or functions within the document object 40 may be declared “public” or available for use by other programmers. The illustrative embodiment of the present invention incorporates the basic principles of object oriented programming and applies it to the creation and use of a document object 40.

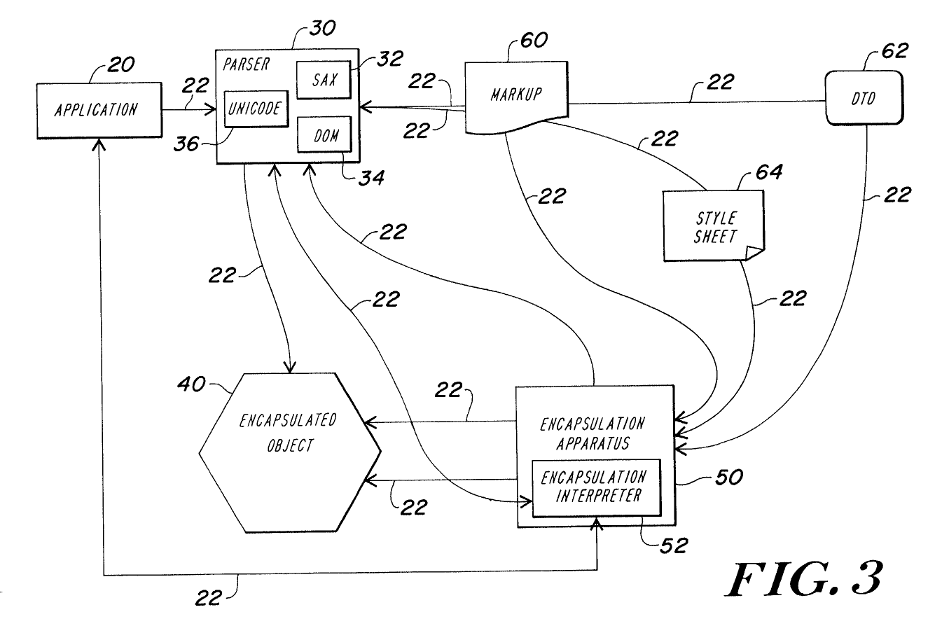

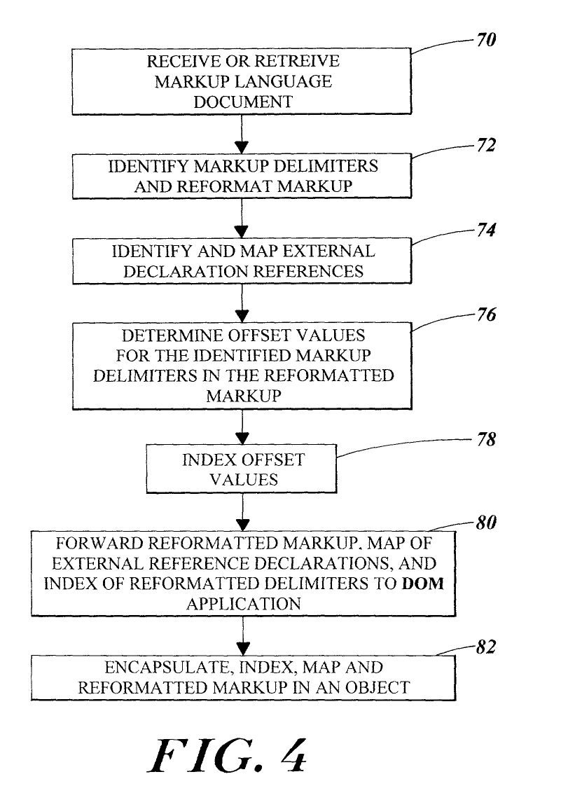

The delimiter index 42 identifies an offset value and a unique I.D. for each delimiter value in the compacted markup language document 46. The delimiters to which the delimiter index 42 references, are tag pairs within the compacted markup language document 46 that delimitate the start and stop of a markup data element. The offset value utilized by the delimiter index 42 indicates a delimiter location as reference from bit zero or a base address of the compacted markup language document 46. One skilled in the art will recognize that the offset value in the delimiter index 42 may utilize the nth bit or last bit in the compacted markup language document 46 as the base address to indicate a delimiter's location within the compacted markup language document 46. The generation of delimiter index 42 will be discussed in more detail below with reference to FIG. 3 and 4.

The reference indicator 44 is a look-up table, an array, or a pointer to preserve the location of an externally referenced markup declaration such as, a document type definition (DTD). Further, the reference indicator 44 also preserves the location of any externally referenced stylesheet. In this manner, the reference indicator 44 preserves an externally referenced markup declaration or stylesheet location that is declared in the compacted markup language document 46. Thus when an application requests data from the compacted markup language document 46, the parser 30 can locate and extract the requested data using the externally referenced DTD, without having to unpack the entire compacted markup language document 46. In an alternative embodiment, the reference indicator 44 may map or point to the compacted externally referenced document type definition (DTD) 48, and the compacted externally referenced stylesheet 49. In this manner the parser 30 utilizes a local version of an externally referenced DTD or stylesheet to retrieve and format markup content from the compacted markup language document 46.

The reference indicator 44 increases the accuracy and reliability of locating the necessary DTD subset or stylesheet when the markup language document is in a compacted format. Because all externally referenced DTDs or stylesheets are neatly packaged in the reference indicator 44 in a decompressed format, a parser or a browser does not have to unpack the entire compacted markup language document 46 to locate an external reference location. The creation of the reference indicator 44 will be discussed in more detail below in connection with the discussion of FIG. 3 and 4.

The two alternative data variables within the document object 40 namely, the compacted externally referenced document type definition (DTD) 48, and the compacted externally referenced stylesheet 49, are a local versions of the externally referenced DTD subsets and stylesheet subsets externally referenced in a markup language document. The ability to localize externally referenced DTDs and stylesheets within the document object 40 ensures the availability of a required DTD to locate and extract content from the compacted markup language document 46 and to format the requested data in its proper format for viewing by the requestor. Having a local version of an externally referenced DTD and stylesheet also provides the benefit of reducing the latency associated with locating and retrieving markup content within the distributed network 10. The creation of the compacted externally referenced document type definition (DTD) 48 and the compacted externally referenced stylesheet 49 within the document logic 40 will be discussed in more detail below with reference to FIG. 3 and 4.

FIG. 3 depicts the interaction of the application program 20, the parser 30, the encapsulation apparatus 50, to create and use the document object 40. The encapsulation apparatus 50 as depicted in FIG. 3 includes an encapsulation interpreter 52. The encapsulation interpreter 52 allows an application program 20 such as a browser application, to directly interface with the encapsulation apparatus 50 to retrieve markup content from the document object 40. The encapsulation interpreter 52 and the application program 20 communicate via interconnect 22. One skilled in the art will recognize that the encapsulation interpreter 52 may be a parser, a browser, or a supplementary application program that is called by a parser or a browser to locate and retrieve the requested markup content in the document object 40.

The encapsulation apparatus 50 may be implemented as a stand-alone apparatus such as a workstation, or a personal computer dedicated to the creation and manipulation of the document object 40. In this manner, the processing power and the speed of the encapsulation apparatus 50 is dedicated to the creation and manipulation of the document object 40. Such a configuration may benefit a network node in a distributed network that operates as a data management node that provides storage for multiple business entities and allows the multiple business entities to share data. Such a network node is depicted as the enterprise storage node 11 of the distributed network 10. One skilled in the art will appreciate that an encapsulation apparatus 50 implemented as a stand-alone apparatus may be configured as a server to time share its processing power to support other server functions.

The parser 30 is a Simple API to XML (SAX) compliant parser that implements a SAX interface 32, a Document Object Model interface 34 (DOM), and a Unicode interface 36. One skilled in the art will recognize that the parser 30 may be a validating markup language parser or may be non-validating markup language parser. The use of the SAX compliment interface 32 provides the parser 30 with an event based interface. As such, the SAX interface 32 utilizes DTD 62 and a markup language document 60 to breakdown the internal structure of the markup language document 60 into a series of linear events. In this manner, the parser 30 reports parsing events such as, the start and end of an element in the markup language document 60 directly to the application program 20 through callbacks. The application program 20 then handles these events in a fashion similar to events from a graphical user interface. The parser 30 and the application program 20 utilize interconnect 22 to locate and retrieve markup content from a markup language document 60, to locate and utilize the DTD 62, and to locate and utilize the associated stylesheet 64.

The DOM interface 34 of the parser 30 is a tree based interface. The DOM interface 34 compiles a markup language document into an internal tree structure to allow the application program 20 to navigate a markup language document via a tree structure. The use of the DOM interface 34 provides the advantage that an application program 20 may modify the document object 40 and then write the document object 40 back to the storage device 24 with a single function call. One skilled in the art will recognize that the DOM interface 34 defines the logical structure of documents and the way a document is accessed and manipulated. As such the DOM interface 34 identifies the interfaces and objects used to represent and manipulate a markup language document. The DOM interface 34 also identifies the semantics of these interfaces and objects, including both behavior and attributes. Further, the DOM interface 34 identifies the relationship and collaborations among these interfaces and objects. Although the DOM interface 34 represents the structure of markup language documents as an object model as compared to the typical abstract data model of markup language documents. One skilled in the art will recognize that the DOM interface 34 is a set of interfaces and objects for managing HTML and XML documents. Hence, the DOM interface 34 may be implemented using language independence systems like the component object model (COM) or the common object request broker architecture (CORBA) and may also be implemented using language specific bindings like JAVA or ECMAscript bindings.

With reference to FIG. 3 and FIG. 4, the encapsulation apparatus 50 creates the document object 40 in the following manner. The encapsulation apparatus 50 may receive or retrieve, via the interconnect 22, the markup language document 60, the externally referenced DTD 62, and the externally referenced stylesheet 64 for encapsulation into the document object 40 (Step 70). The encapsulation engine 50 then proceeds to identify the markup delimiters in the markup language document 60 by utilizing the declaration definitions in the DTD 62 and proceeds to compact the markup language document 60 into a format that utilizes less memory for storage (Step 72). As the encapsulation engine 50 is compacting the markup language document 60 into the compacted format, the encapsulation apparatus 50 identifies any externally referenced declaration or stylesheet and utilizes the external reference details to generate the reference indicator 44. The encapsulation engine 50 may also replicate any externally referenced DTD and stylesheet for inclusion in the document object 40 as unique entities in a compacted format (Step 74). Thus, the document object 40 may include a local version of any externally referenced DTD or stylesheet to reduce latency associated with content retrieval and to ensure the availability of an externally referenced DTD or stylesheet. The reference indicator 44 may be implemented as a lookup table, as an array, as a pointer, or the like. The compression technique or method utilized by the encapsulation engine 50 may be any conventional compression or compaction technique, for example WinZip® or Java® internal compression.

While compacting the markup language document 60, the encapsulation apparatus 50 generates an offset value for each markup delimiter identified in step 72 above (Step 76). The encapsulation apparatus 50 also generates an index of identified delimiters and their associated offset value that indicates their location in the compacted markup language document 46 (Step 78). The encapsulation apparatus 50 forwards the collection of entities to the DOM interface 34 in order to specify the object structure of the document object 40 (Step 80). The DOM interface 34 through a COM application, a COBRA application, or a JAVA application, assists the encapsulation apparatus 50 in the creation of the document object 40 (Step 82).

In this manner, a markup language document may be encapsulated into an object to preserve memory space required for storage, and to conserve or reduce system bandwidth required to transmit a markup language document through the distributed network 10. Moreover, the creation of the document object 40 reduces latency associated with accessing specific markup content, because the parser is provided with a pre-constructed index of delimiters in order to accelerate the location and retrieval of content.

For an application program 20 to access and retrieve markup content from the document object 40, two alternative methods are described in detail below. The first method allows the application program 20 to directly interface with the encapsulation apparatus 50 in order to retrieve or modify markup content in the document object 40. In the second method, the application program 20 utilizes the parser 30 to interface with the encapsulation apparatus 50 in order to retrieve and modify markup content from the document object 40.

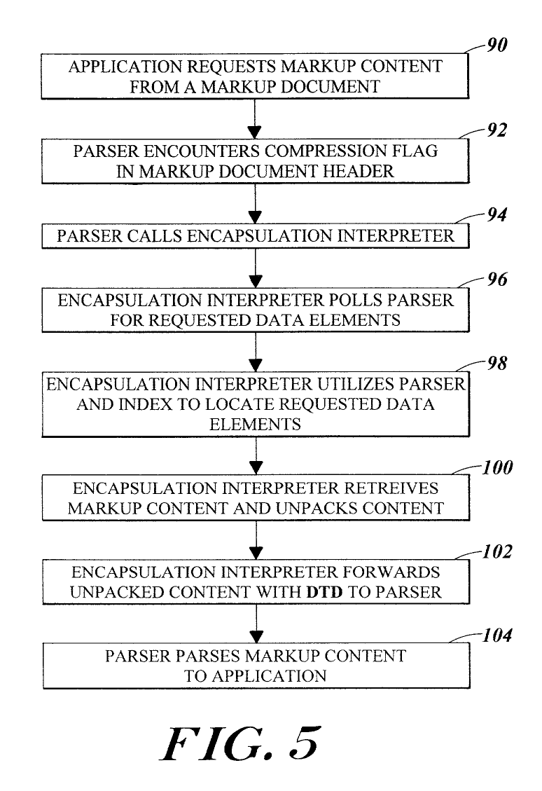

With reference to FIG. 3 and FIG. 5, the encapsulation apparatus 50 may provide an encapsulation interpreter 52 to support direct retrieval of markup content from the document object 40 by the application program 20. The method depicted in FIG. 5 uses the parser 30 to communicate with the encapsulation interpreter 52. When the application program 20 sends a request to the parser 30 for a markup language document, the Unicode interface 36 examines the header of the request to determine whether or the requested markup language document is a compacted or not (Step 90). One skilled in the art will recognize that the Unicode Standard reserves code points for private use. Such a private use is the adoption of a private code to indicate whether the markup language document is compacted or not.

If the Unicode interface 36 determines that the requested markup language document is not encapsulated into the document object 40, the parser 30 utilizes the available SAX interface 32 to parse the markup language document 60 and retrieve the requested markup content. Should the Unicode interface 36 identify from the request header that the content is in a compressed format in a document object 40 (Step 92), the parser 30 calls the encapsulation interpreter 52 to establish communications (Step 94). The encapsulation interpreter 52 responds by polling the parser 30 for the requested data elements and the requested document object 40 (Step 96). Upon receipt of the requested data elements, the encapsulation interpreter 52 utilizes the delimiter index 42, and the parser 30 to navigate the object structure of the document object 40 in order to locate the requested markup content (Step 98). The encapsulation interpreter 52 may access the parser 30 via the encapsulation apparatus 50 or via a direct interface. Once the encapsulation interpreter 52 locates the requested markup content, the encapsulation interpreter retrieves and unpacks the markup content (Step 100). When the requested markup content is unpacked, the encapsulation interpreter 52 forwards the markup content and the required DTD to the parser 30 (Step 102). The parser 30 then parses the retrieved markup content to the application program 20 (Step 104).

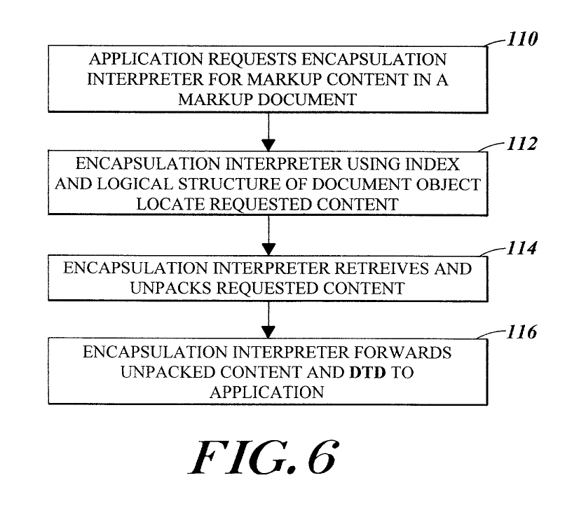

The second method for retrieving markup content from the document object 40 is illustrated in FIG. 6. The second method for retrieving markup content from the document object 40 supports the direct interface of the application program 20 with the encapsulation interpreter 52. Should the application program 20 need to retrieve markup content from the document object 40, the application program 20 places a call to the encapsulation interpreter 52 to initiate the retrieval of the markup content from the document object 40 (Step 110). The encapsulation interpreter 52 then polls the application program 20 to identify the requested content and uses the delimiter index 42 to navigate the object structure of the document object 40 to locate the requested markup content (Step 112). When the encapsulation interpreter 52 locates the requested markup content, the encapsulation interpreter 52 retrieves and unpacks the requested markup content along with retrieving and unpacking the associated DTD and stylesheet (Step 114). The encapsulation interpreter 52 forwards the unpacked markup content along with unpacked DTD and associated stylesheet to the application program 20 (Step 116). This method further expedites the extraction of compacted markup content from the document object 40 by bypassing the parser interface. In this manner, the encapsulation interpreter 52 may be implemented as a supplementary program such as a plug-in that adds functionality to a browser application.

One skilled in the art will appreciate that the above described embodiments of the present invention may also be practiced in non-object oriented environments, where the delimiter index, the reference indicator, and the compacted markup language document are not encapsulated into an object per se, but rather held in data structures that are not objects. Further, those skilled in the art will appreciate that the delimiter index, the reference indicator, and the compacted markup language document may be encapsulated into one or more objects where each entity may be a discrete object without departing from the scope of the above described embodiments.

While the present invention has been described with referenced to an illustrative embodiment thereof, those skilled in the art will appreciate that various changes in form may be made without departing the intended scope of the present invention as defined in the appended claims.

What is claimed is:

1. A method for encapsulating a markup language object, the method comprising the step of:
identifying a delimiter pair in a markup language document;
compacting the markup language document;
generating an index value for the compacted delimiter pair; and
encapsulating the compacted markup language document and the generated index value into the markup language object.

2. The method of claim 1 further comprising the step of:
generating a pointer to a referenced markup declaration; and
generating a pointer to a referenced stylesheet for application to the markup language document.

3. The method of claim 1 further comprising the step of generating an index for the generated index value, wherein the index associates the identified delimiter pair with the generated index value.

4. The method of claim 2 further comprising the steps of:
compacting the referenced markup declaration into a unique entity for inclusion in the markup language object; and
compacting the referenced stylesheet into a unique entity for inclusion in the markup language object.

5. The method of claim 1, wherein the delimiter pair comprises a start tag that indicates where a unit of information begins and an end tag that indicate where the unit of information ends.

6. The method of claim 1, wherein the markup language document is a HyperText Markup Language (HTML) document.

7. The method of claim 1, wherein the markup language document is an eXtensible Markup Language (XML) document.

8. The method of claim 5, wherein the index value comprises an offset value for the start tag and an offset value for the end tag to indicate the start tag location and the end tag location in the encapsulated object.

9. The method of claim 2, wherein the markup declaration is a document type definition (DTD).

10. An apparatus for formatting a markup language object for distribution in a distributed network, comprising:
a search facility for identifying content boundary markers in a markup language document;
a formatting facility that reformats the identified content boundary markers into a format that requires less storage space than the content boundary markers original format and that also reformats the content within the identified content boundary markers in a format that requires less storage space than the content within the identified content boundary markers original format;
an index facility that generates an index value for the formatted boundary markers; and
an encapsulation facility that encapsulates the index value, the formatted content boundary markers and the formatted content into the markup language object.

11. The apparatus of claim 10 further comprising,
a reference facility for generating a reference map to locating external markup declarations and external style sheets referenced in the markup language document.

12. The apparatus of claim 10, further comprising, a markup language processor, wherein said markup language processor parses content selected from the markup language object to an application program for data manipulation.

13. The apparatus of claims 10, wherein the index facility generates an index of said index values, wherein the index maps the generated index value to the identified content boundary markers.

14. The apparatus of claim 10, wherein the markup language object is a HyperText Markup Language (HTML).

15. The apparatus of claim 10, wherein the markup language object is a Extensible Markup Language (XML) object.

16. The apparatus of claim 10, wherein said apparatus is a web server.

17. The apparatus of claim 10, wherein the content boundary markers comprise a start tag and an end tag, wherein the start tag indicates where a unit of information begins and the end tag indicates where the unit of information ends.

18. The apparatus of claim 10, wherein the index value generated by the index facility comprises a formatted offset value for each of the identified content boundary markers.

19. The apparatus of claim 11, wherein the reference facility includes an array of uniform resource identifiers.

20. The apparatus of claim 12, wherein the markup language processor includes a markup language parser.

21. The apparatus of claim 11, wherein the external markup declaration is a document type definition (DTD).

22. The apparatus of claim 10, wherein the identified content boundary markers are nested.

23. A computer readable medium holding computer executable instructions for performing a method to encapsulate a markup language object, said method comprising the steps of:
locating a pair of language element descriptors in a markup language document;
reformatting the pair of language element descriptors and markup within the pair of language element descriptors into a format that requires less memory than their original format;
generating an index for offset values for the formatted language element descriptors to indicate a location of the formatted language element descriptors; and
encapsulating the reformatted language element descriptors, the reformatted markup, and the offset value into a markup language object.

24. Th computer readable medium of claim 23, further comprising the steps of:
generating a variable to indicate a markup declaration location; and
generating a variable to indicate a stylesheet location for application to the markup language document.

25. The computer readable medium of claim 23, further comprising the step of generating an index of said offset values, wherein said index associates said offset values and said formatted language element descriptors.

26. The computer readable medium of claim 23, wherein the markup language document is a HyperText Markup Language (HTML) document.

27. The computer readable medium of claim 23, wherein the markup language document is an eXtensible Markup Language (XML) document.

28. The computer readable medium of claim 23, wherein the pair of language element descriptors comprises a start tag and an end tag, wherein the start tag indicates where a unit of information begins and the end tag indicates where said unit of information ends.

29. The computer readable medium of claim 28, wherein the start tag has an offset value and the end tag has an offset value.

30. The computer readable medium of claim 24, wherein the markup declaration comprises a Declaration Type Definition (DTD).

31. A method for distributing a markup language document in a distributed system, the method comprising the steps of:
encapsulating the markup language document into an object so that said encapsulated object comprising elements of the markup language document in a compressed format, an index indicating locations of the compressed elements in the object, and a pointer indicating a markup declaration location; and
forwarding the encapsulated object to an application for use.

32. The method of claim 31 wherein the encapsulated object further comprises a pointer to indicate a stylesheet location.

33. The method of claim 31 wherein the markup declaration comprises a Document Type Definition (DTD).

34. A method for distributing a markup language document via a distributed network, the method comprising the steps of:
identifying units of information within the markup language document;
compressing the markup language document into a compressed format;
generating an index file that lists each of the identified units of information and a physical location for each of the identified units of information in the compressed markup language document;
generating a table of values that preserves a location of an externally referenced document declaration in the markup language document and that preserves a location of an externally referenced stylesheet for application to the markup language document; and
distributing the compressed markup language document, the index file, and the table of values to one or more nodes of the distributed network.

35. The method of claim 34 further comprising the step of, generating a local file comprising the externally referenced document declaration and the externally referenced stylesheet.

36. The method of claim 34, wherein the externally referenced document declaration is a document type definition (DTD).
